(19) United States
(12) Patent Application Publication
(10) Pub. No.: US 2013/0111018 A1
(43) Pub. Date: May 2, 2013

(54) PASSIVE MONITORING OF VIRTUAL SYSTEMS USING AGENT-LESS, OFFLINE INDEXING

(71) Applicants: Glenn S. Ammons, West Chester, PA (US); Ahmed M. Azab, Raleigh, NC (US); Vasanth Bala, Rye, NY (US); Sastry S. Duri, Yorktown Heights, NY (US); Todd W. Mummert, Danbury, CT (US); Darrell C. Reimer, Tarrytown, NY (US); Lakshminarayanan Renganarayana, Elmsford, NY (US); Xiaolan Zhang, Chappaqua, NY (US)

(72) Inventors: Glenn S. Ammons, West Chester, PA (US); Ahmed M. Azab, Raleigh, NC (US); Vasanth Bala, Rye, NY (US); Sastry S. Duri, Yorktown Heights, NY (US); Todd W. Mummert, Danbury, CT (US); Darrell C. Reimer, Tarrytown, NY (US); Lakshminarayanan Renganarayana, Elmsford, NY (US); Xiaolan Zhang, Chappaqua, NY (US)

(73) Assignee: INTERNATIONAL BUSINESS MACHINES COPORATION, Armonk, NY (US)

(21) Appl. No.: 13/527,948

(22) Filed: Jun. 20, 2012

Related U.S. Application Data
(60) Provisional application No. 61/552,797, filed on Oct. 28, 2011.

(51) Int. Cl. G06F 15/173

(52) U.S. Cl. 709/224

(57) ABSTRACT

Aspects of the present invention provide a solution for passively monitoring a computer system. In an embodiment, a virtual server is accessed by an indexing agent that is contained in an indexing appliance. The virtual server is located on a physical server and is one of a plurality of virtual system instances on a common physical server. The indexing appliance is separate from the virtual server and, as such, the indexing agent is not executed within the virtual server, itself. The indexing agent retrieves a virtual image of the virtual server and indexes the virtual image to extract features indicative of changes in the virtual server. These features are analyzed to perform passive monitoring of the virtual server. Since the indexing appliance is separate from the virtual server for which passive monitoring is being performed, the indexing agent can perform the retrieving and the indexing without utilizing agents executing within the virtual server.

### CROSS-REFERENCE TO RELATED APPLICATIONS

This patent application claims the benefit of co-pending U.S. Provisional Application No. 61/552,797, filed on Oct. 28, 2011, which is hereby incorporated herein by reference.

This patent application is related to patent application filed concurrently herewith, Ser. No. ______, Attorney Docket Number YOR920110713US1, entitled PASSIVE MONITORING OF VIRTUAL SYSTEMS USING EXTENSIBLE INDEXING.

### TECHNICAL FIELD

The subject matter of this invention relates generally to computer systems management. More specifically, aspects of the present invention provide a solution for improved passive monitoring in a complex virtual environment.

### BACKGROUND

In the electronic environment of today, computer systems undergo constant changes. In order to keep up with these changes, it is important that users of these systems be able to monitor the systems. Monitoring can be classified into several different types, including active monitoring and passive monitoring. Passive monitoring includes any observation that does not modify a computer system. To this extent, passive monitoring can include scanning a file system to perform a compliance check, scanning a registry to determine which applications are currently installed on the system, security scanning, file system inspection, license usage monitoring, and the like. In contrast, activities, such as patching, applying a security update, etc., that involve modification of the computer system are referred to as active monitoring.

Standardization can be an asset in effective systems management. Standardization of a data center helps customers control maintenance costs by limiting the number of different variations of systems running in the data center. This allows costs to grow in proportion to the number of different software configurations rather than in proportion to the number of different instances of those configurations.

To realize some of the benefits of standardization, providers of a computer system can insure that all deployed instances begin their lifecycle from one or more standard “images” or pre-configured software stacks. However, once an instance begins execution, it can deviate from this standardized state due to changes within the instance. These changes can be accidental, intentional but without harmful intent, or malicious in nature. In any case, these con-compliant deviations can cause the particular instance not to function correctly and/or can affect the efficiency of the instance within the overall computer system, possibly impacting other instances and/or the overall efficiency of the computer system.

Existing solutions for providing drift detection and other passive monitoring services use agents that must be installed inside every system instance. These agents periodically scan some or all portions of the file system of the instance and send the scanned information to a central server. However, as the number of instances, and each instance's accompanying agent, increases, the impact of the agents on the capacity, function and/or communications of the computer system increases, and these agents use resources that could otherwise be devoted to the designed function of the computer system.

### SUMMARY

In general, aspects of the present invention provide a solution for passively monitoring a computer system. In an embodiment, a virtual server is accessed by an indexing agent that is contained in an indexing appliance. The virtual server is located on a physical server and is one of a plurality of virtual system instances on a common physical server. The indexing appliance is separate from the virtual server and, as such, the indexing agent is not executed within the virtual server, itself. The indexing agent retrieves a virtual image of the virtual server and indexes the virtual image to extract a set of features indicative of changes in the virtual server. One or more of, these extracted features are analyzed to perform passive monitoring of the virtual server. Since the indexing appliance is separate from the virtual server for which passive monitoring is being performed, the indexing agent can perform the retrieving and the indexing without utilizing agents executing within the virtual server.

A first aspect of the invention provides a method for passively monitoring a computer system, comprising: accessing a virtual server by an indexing agent that is contained in an indexing appliance separate from the virtual server, the virtual server being one of a plurality of virtual system instances on a common physical server; retrieving a virtual image of the virtual server by the indexing agent; indexing the virtual image by the indexing appliance to extract a set of features indicative of changes in the virtual server; and analyzing at least one of the set of features to perform passive monitoring of the virtual server, wherein the retrieving and the indexing are performed without utilizing agents executing within the virtual server.

A second aspect of the invention provides a system for passively monitoring a computer system, comprising: a physical server having a plurality of virtual system instances operating thereon; and an indexing appliance operating on the physical server, which performs a method comprising: using an indexing agent that is contained in the indexing appliance to access a virtual server from among the plurality of virtual systems instances, the virtual server being separate from the indexing appliance; retrieving a virtual image of the virtual server by the indexing agent; indexing the virtual image by the indexing appliance to extract a set of features indicative of changes in the virtual server; and analyzing at least one of the set of features to perform passive monitoring of the virtual server, wherein the retrieving and the indexing are performed without utilizing agents executing within the virtual server.

A third aspect of the invention provides a computer program product embodied in a computer readable medium for implementing a method for passively monitoring a computer system, the method comprising: accessing a virtual server by an indexing agent that is contained in an indexing appliance separate from the virtual server, the virtual server being one of a plurality of virtual system instances on a common physical server; retrieving a virtual image of the virtual server by the indexing agent; indexing the virtual image by the indexing appliance to extract a set of features indicative of changes in the virtual server; and analyzing at least one of the set of features to perform passive monitoring of the virtual server, wherein the retrieving and the indexing are performed without utilizing agents executing within the virtual server.

A fourth aspect of the present invention provides a method for deploying an application for passively monitoring a computer system, comprising: providing a computer infrastructure being operable to: access a virtual server by an indexing agent that is contained in an indexing appliance separate from the virtual server, the virtual server being one of a plurality of virtual system instances on a common physical server; retrieve a virtual image of the virtual server by the indexing agent; index the virtual image by the indexing appliance to extract a set of features indicative of changes in the virtual server; and analyze at least one of the set of features to perform passive monitoring of the virtual server, wherein the retrieving and the indexing are performed without utilizing agents executing within the virtual server.

Still yet, any of the components of the present invention could be deployed, managed, serviced, etc., by a service provider who offers to implement passive monitoring in a computer system.

Embodiments of the present invention also provide related systems, methods and/or program products.

### BRIEF DESCRIPTION OF THE DRAWINGS

These and other features of this invention will be more readily understood from the following detailed description of the various aspects of the invention taken in conjunction with the accompanying drawings in which:

FIG. 1 shows an illustrative computer system according to embodiments of the present invention.

FIG. 2 shows a virtualized datacenter environment according to embodiments of the invention.

FIG. 3 shows an example virtual server according to embodiments of the invention.

FIG. 4 shows an example server having an indexing appliance according to embodiments of the invention.

FIG. 5 shows example comparison analyses according to embodiments of the invention.

FIG. 6 shows an example flow diagram according to embodiments of the invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

As indicated above, aspects of the present invention provide a solution for passively monitoring a computer system. In an embodiment, a virtual server is accessed by an indexing agent that is contained in an indexing appliance. The virtual server is located on a physical server and is one of a plurality of virtual system instances on a common physical server. The indexing appliance is separate from the virtual server and, as such, the indexing agent is not executed within the virtual server, itself. The indexing agent retrieves a virtual image of the virtual server and indexes the virtual image to extract features indicative of changes in the virtual server. These features are analyzed to perform passive monitoring of the virtual server. Since the indexing appliance is separate from the virtual server for which passive monitoring is being performed, the indexing agent can perform the retrieving and the indexing without utilizing agents executing within the virtual server.

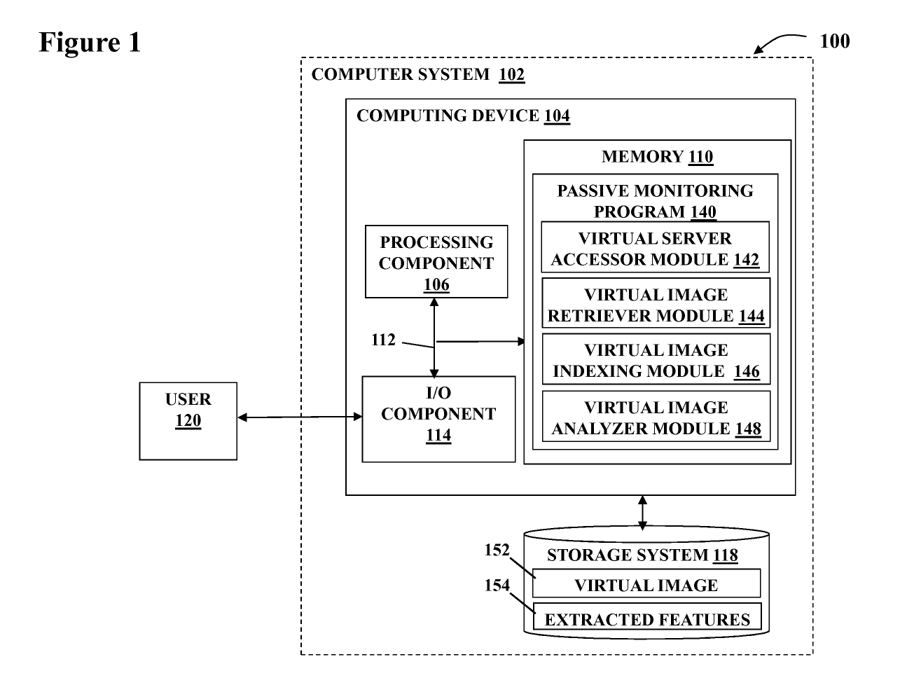

Turning to the drawings, FIG. 1 shows an illustrative environment 100 for passively monitoring a computer system. To this extent, environment 100 includes a computer system 102 that can perform a process described herein in order to passively monitor a computer system. In particular, computer system 102 is shown including a computing device 104 that includes a passive monitoring program 140, which makes computing device 104 operable to passively monitor a computer system by performing a process described herein.

Computing device 104 is shown including a processing component 106 (e.g., one or more processors), a memory 110, a storage system 118 (e.g., a storage hierarchy), an input/output (I/O) interface component 114 (e.g., one or more I/O interfaces and/or devices), and a communications pathway 112. In general, processing component 106 executes program code, such as passive monitoring program 140, which is at least partially fixed in memory 110. To this extent, processing component 106 may comprise a single processing unit, or be distributed across one or more processing units in one or more locations.

Memory 110 also can include local memory, employed during actual execution of the program code, bulk storage (storage 118), and/or cache memories (not shown) which provide temporary storage of at least some program code in order to reduce the number of times code must be retrieved from bulk storage 118 during execution. As such, memory 110 may comprise any known type of temporary or permanent data storage media, including magnetic media, optical media, random access memory (RAM), read-only memory (ROM), a data cache, a data object, etc. Moreover, similar to processing unit 116, memory 110 may reside at a single physical location, comprising one or more types of data storage, or be distributed across a plurality of physical systems in various forms.

While executing program code, processing component 106 can process data, which can result in reading and/or writing transformed data from/to memory 110 and/or I/O component 114 for further processing. Pathway 112 provides a direct or indirect communications link between each of the components in computer system 102. I/O interface component 114 can comprise one or more human I/O devices, which enable a human user 120 to interact with computer system 102 and/or one or more communications devices to enable a system user 120 to communicate with computer system 102 using any type of communications link.

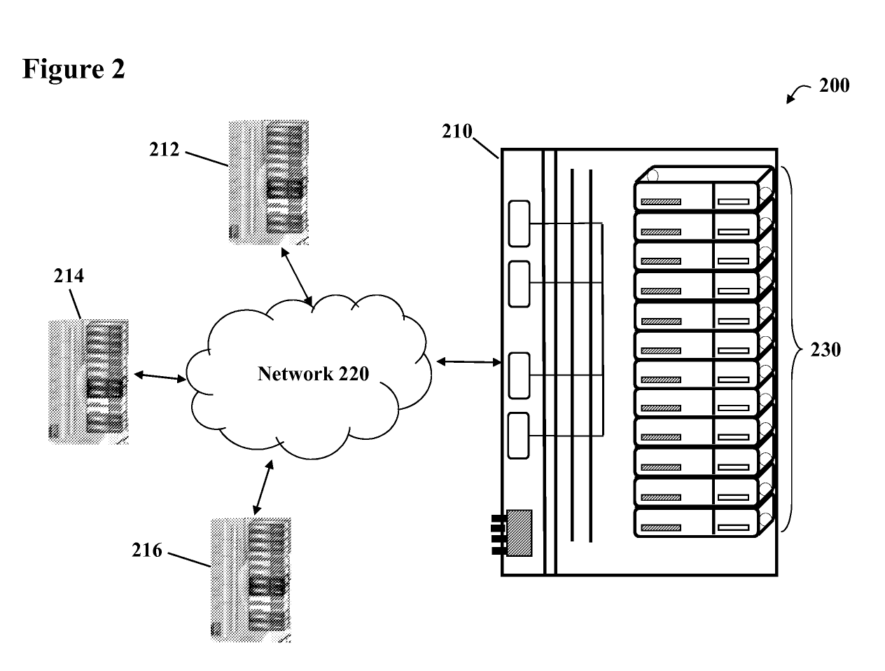

To this extent, passive monitoring program 140 can manage a set of interfaces (e.g., graphical user interface(s), application program interface, and/or the like) that enable human and/or system users 120 to interact with passive monitoring program 140. Users 120 could include system administrators and/or clients utilizing resources in a virtual data center environment 200 (FIG. 2), among others. Further, passive monitoring program 140 can manage (e.g., store, retrieve, create, manipulate, organize, present, etc.) the data in storage system 118, including, but not limited to a virtual image 152 and/or extracted features 154, using any solution.

In any event, computer system 102 can comprise one or more computing devices 104 (e.g., general purpose computing articles of manufacture) capable of executing program code, such as passive monitoring program 140, installed thereon. As used herein, it is understood that “program code” means any collection of instructions, in any language, code or notation, that cause a computing device having an information processing capability to perform a particular action either directly or after any combination of the following: (a) conversion to another language, code or notation; (b) reproduction in a different material form; and/or (c) decompression. To this extent, passive monitoring program 140 can be embodied as any combination of system software and/or application software. In any event, the technical effect of computer system 102 is to provide processing instructions to computing device 104 in order to passively monitor a computer system.

Further, passive monitoring program 140 can be implemented using a set of modules 142-148. In this case, a module 142-148 can enable computer system 102 to perform a set of tasks used by passive monitoring program 140, and can be separately developed and/or implemented apart from other portions of passive monitoring program 140. As used herein, the term “component” means any configuration of hardware, with or without software, which implements the functionality described in conjunction therewith using any solution, while the term “module” means program code that enables a computer system 102 to implement the actions described in conjunction therewith using any solution. When fixed in a memory 110 of a computer system 102 that includes a processing component 106, a module is a substantial portion of a component that implements the actions. Regardless, it is understood that two or more components, modules, and/or systems may share some/all of their respective hardware and/or software. Further, it is understood that some of the functionality discussed herein may not be implemented or additional functionality may be included as part of computer system 102.

When computer system 102 comprises multiple computing devices 104, each computing device 104 can have only a portion of passive monitoring program 140 fixed thereon (e.g., one or more modules 142-148). However, it is understood that computer system 102 and passive monitoring program 140 are only representative of various possible equivalent computer systems that may perform a process described herein. To this extent, in other embodiments, the functionality provided by computer system 102 and passive monitoring program 140 can be at least partially implemented by one or more computing devices that include any combination of general and/or specific purpose hardware with or without program code. In each embodiment, the hardware and program code, if included, can be created using standard engineering and programming techniques, respectively.

Regardless, when computer system 102 includes multiple computing devices 104, the computing devices can communicate over any type of communications link. Further, while performing a process described herein, computer system 102 can communicate with one or more other computer systems using any type of communications link. In either case, the communications link can comprise any combination of various types of wired and/or wireless links; comprise any combination of one or more types of networks; and/or utilize any combination of various types of transmission techniques and protocols.

As discussed herein, passive monitoring program 140 enables computer system 102 to passively monitor a computer system. To this extent, passive monitoring program 140 is shown including a virtual server accessor module 142, a virtual image retriever module 144, a virtual image indexing module 146, and a virtual image analyzer module 148.

Computer system 102, executing virtual server accessor module 142 accesses a virtual server through an indexing agent that is contained in an indexing appliance.

Referring now to FIG. 2, a virtualized datacenter environment 200 according to embodiments of the invention is shown. As shown, virtual datacenter environment 200 has a physical server 210 that can be used to perform all or a portion of the functions of passive monitoring program 140 (FIG. 1). To this extent, physical server 210 can be a server from any manufacturer that runs any platform that is adapted to run multiple instances of a virtual server 230. As illustrated in FIG. 2, virtualized datacenter environment 200 can also contain any number of related physical servers 212, 214, 216. Related physical servers 212, 214, 216 can be connected with physical server 210 for communication purposes via a network 220. Network 220 can allow physical server 210 to communicate with related physical servers 212, 214, 216 and/or physical servers 212, 214, 216 to communication with one another using any communications solution or solutions now known or later developed. In some embodiments, network 220 can operate on a cloud computing scale, providing, e.g., computation, software, data access, and other services that do not require end-user knowledge of the physical location and configuration of the network 220 that delivers the services.

In any case, as stated above, each instance of virtual server 230 on physical server 210 can operate simultaneously with other systems instances 230 while maintaining independence. This means that each of the instances of virtual server 230 operates independently of other instances of virtual server 230 and does not share information with other instances of virtual server 230 even though the instances of virtual server 230 operate on the same physical server 210. Owing to the characteristics of these instances of virtual server 230, a single physical server 210 can execute a very large number of instances of virtual server 230 concurrently. The independent operation of these instances of virtual server 230 ensures that the number of concurrent instances of virtual server 230 is only limited by the hardware constraints of physical server 210.

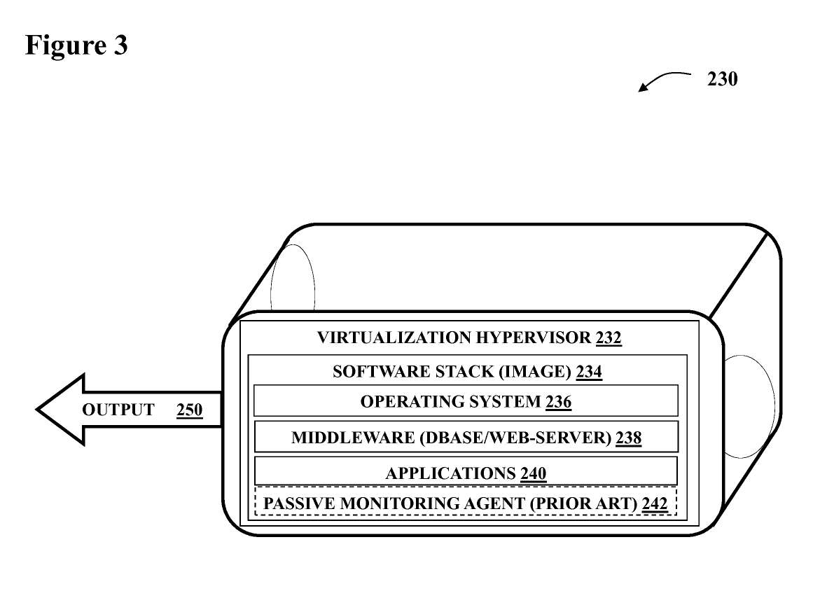

Turning now to FIG. 3, an example virtual server 230 according to embodiments of the invention is shown. It should be understood that virtual server 230 is different from a process virtual machine. A process virtual machine is a platform dependent engine, such as a Java Virtual Machine, that executes platform independent code written in a high-level programming language, such as Java, for performing a specific task (Java and Java Virtual Machine are a trademark of Sun Microsystems in the United States and/or elsewhere). In contrast, the virtual server 230 of the current invention is a virtual system that simulates an entire computing environment. To this extent, rather than performing only a single task, the virtual server 230 of the current invention is an environment within which a variety of tasks, functions, operations, etc., can be carried out by a user 120 (FIG. 1). As such, virtual server 230 can be made to simulate a stand-alone computer system in the eyes of a user 120 (FIG. 1).

To this extent, virtual server 230, includes a virtualization hypervisor 232 at the lowest level. Specifically, virtualization hypervisor 232 provides a platform that allows multiple “guest” systems to run concurrently on the physical server 210 (FIG. 2). To this extent, virtualization hypervisor 232 provides an abstraction level between the hardware level of physical server 210 (FIG. 2) and the higher level software functions of the virtual server 230. In order to provide these software functions, virtual server 230 includes a software stack 234, which can also be referred to as an image. Software stack 234 contains everything that is necessary to simulate a “guest” instance of virtual server 230 on physical server 210 via virtualization hypervisor 232. To this extent, software stack 234 can provide an operating system 236, middleware 238, and applications 240.

As stated above, standardization at this level can significantly decrease maintenance costs by limiting the number of different variations of systems running in virtualized datacenter environment 200. To achieve this, a specific software stack 234 can be generated from one of a limited number of preconfigured stacks. These pre-configured stacks can be optimized for their particular function by providers of virtualized datacenter environment 200 (FIG. 2). For example, if a user 120 (FIG. 1) wants to utilize database functionality, one or more virtual servers 230 having the same software stack 234 based on the same preconfigured stack can be generated specifically for this user 120. These software stacks 234 could, for example, contain an operating system 236 of a type that is appropriate for performing database functions, middleware 238 that contains a database management system, and applications 240 that are configured to run against the database management system. Similarly, if a user 120 (FIG. 1) wants to utilize web server functionality, one or more virtual servers 230 having the same software stack 234 based on a different preconfigured stack from the preconfigured stack used for the database management system can be generated specifically for that user 120. These software stacks 234 could, for example, contain operating system 236 of a type that is appropriate for web server functions, middleware 238 that contains a web server management system, and applications 240 that are configured to run against the web server management system. It should be understood that software stacks 234 that are adapted to perform various other functions within virtualized datacenter environment could be generated as well. To this extent, operating system 236 can include any operating system now known or later developed. Further, middleware 238 and applications 240 can include any solutions that can be envisioned for providing the desired functionality for a particular virtual server 230.

However, insuring that virtual servers 230 are created using standardized preconfigured stacks does not guarantee that a particular instance of virtual server 230 will remain within acceptable parameters once a user 120 (FIG. 1) begins utilizing it. For example, one user 120 may make an inadvertent change to a software stack 234 that makes the corresponding virtual server 230 non-compliant. Alternatively, a user 120 may make an intentional change to a software stack 234 without knowledge that the change has made the software stack 234 non-compliant. Still further, a non-compliant change can be introduced maliciously, such as from malware that has been inadvertently loaded onto virtual server 230 by user 120. In any case, such non-compliant changes in the software stack 234 of a particular instance of virtual server 230 can cause virtual server 230 to function inefficiently or incorrectly. Because, the physical space utilized by virtual server 230 is utilized also by other virtual servers 230 (FIG. 2) as well, changes of this sort can cause an immediate or gradual degradation of virtualized datacenter environment 200 system functions.

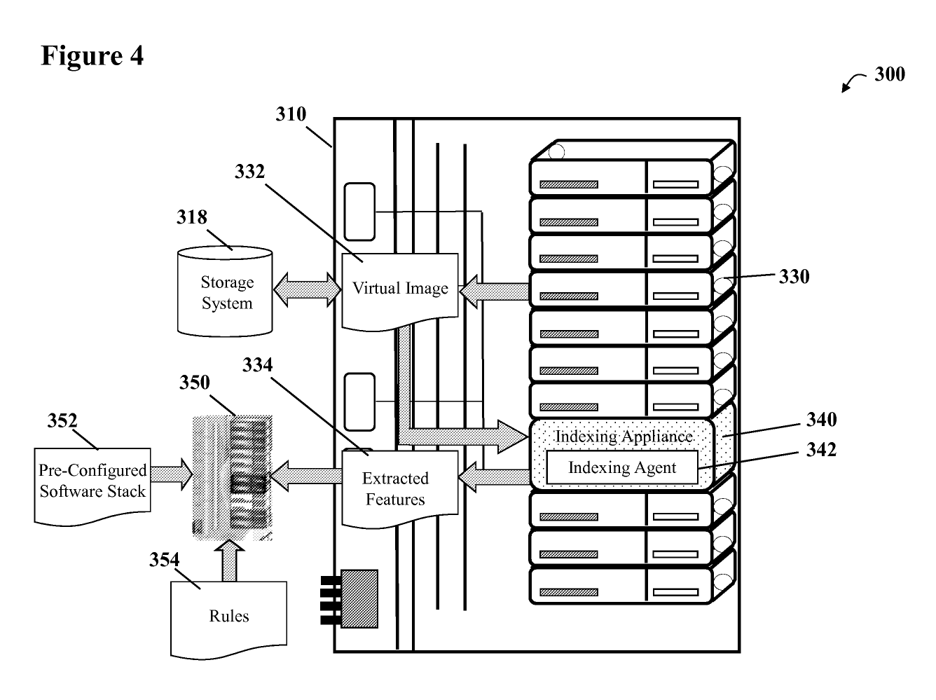

To counteract this problem, solutions have been proposed for passively monitoring a virtual server 230 to detect deviation in the virtual server 230 deriving from such non-compliant changes. FIG. 3 illustrates one such prior art solution in which a passive monitoring agent 242 is installed in every instance of virtual server 234 in the virtualized datacenter environment 200. However, the inventors of the present application have discovered some shortcomings of this approach. For example, as shown in FIG. 3 the addition of passive monitoring agent 242 to virtual server 230 uses resources, expanding the “footprint” of virtual server 230 within virtualized datacenter environment 200. Although this expanded footprint may be small in absolute terms for a single virtual server 230, it can become significant in a system, such as virtualized datacenter environment 200 in which a very large number of virtual servers 234, each of which has its own passive monitoring agent 242, are competing for resources on physical server 210. In addition, the inventors of the present invention have discovered that if each passive monitoring agent 242 is required to report to a central detection server 350 (FIG. 4) the combined output 250 from the reporting passive monitoring agents 242 can constrict, if not overwhelm, communications across network 220 (FIG. 2). Still further, because of the rapidly evolving nature of threats due to malware, passive monitoring agent 242 may need to be updated frequently. The large number of passive monitoring agents 242 in the virtual servers 234 in virtualized datacenter environment 200 can require significant resources for locating, checking the status of the virtual servers 234 and updating the passive monitoring agents 242, if necessary.

Turning now to FIG. 4, an environment 300 that includes an example physical server 310 having an indexing appliance 340 according to embodiments of the invention is shown. As illustrated, indexing appliance 340 is separate from virtual servers 330 on physical server 310 in virtualized datacenter environment 300, and can itself be a virtual server 330. Indexing appliance 340 contains an indexing agent 342 that can perform passive monitoring services for the entire physical server 310. Indexing agent 342 can access any instance of virtual server 330 via virtualization hypervisor 232 (FIG. 3) to perform all of the functions that are necessary for passive monitoring. One result of this is that passive monitoring agents 242 (FIG. 3) can be removed entirely from all instances of virtual server 330. Thus, the overall amount of resources dedicated to passive monitoring can be significantly reduced even when the amount of resources that are dedicated to the indexing appliance 340 are taken into account.

Turning now to FIGS. 1, 3 and 4, concurrently, virtual image retriever module 144, as executed by computer system 102, can retrieve a virtual image 332 of a particular instance of virtual server 330 for which passive monitoring is desired using indexing agent 342. This retrieving can be in response to a request sent to indexing appliance 340 from a central detection server 350 that instructs indexing appliance 340 to perform passive monitoring on a particular instance of virtual server 330 and provides an address at which the virtual server 330 instance is located. In some embodiments, indexing agent 342 can then instruct virtualization hypervisor 232 of virtual server 330 to perform a checkpoint operation in virtual server 330. In these embodiments the checkpoint operation can be a function within virtualization hypervisor 232 that takes a “snapshot” virtual image 332 of the software stack 234 of the virtual server 330. Virtual image 332 can include data corresponding to both the file system and running state, as well as any other information in software stack 234 at the time of the “snapshot”.

In other embodiments, the instruction to checkpoint virtual server 330 can originate from places other than indexing appliance 340. For example, checkpoint operations can automatically occur periodically, such as part of a backup and/or recovery operation. However, the present invention does not depend on the manner in which virtual image 332 was produced, but rather any solution for producing a virtual image 332 of a software stack 234 of a virtual server 330 now known or later developed is envisioned. In any event, upon creation, virtual image 332 can be retrieved directly by indexing agent 342. In the alternative, virtual image 332 can be stored in a storage system 318 for later retrieval by indexing agent 342. It should be understood that storage system 318 can be included within and/or can be external to physical server 310 and can utilize any storage solution.

Referring still to FIGS. 1, 3 and 4, concurrently, virtual image indexing module 146, as executed by computer system 102, can index the virtual image 332 of a virtual server 330 retrieved by virtual image retriever module 144. This indexing can be performed by indexing agent 342 within indexing appliance 340. As such, the indexing is performed outside of virtual server 330, itself, and can be performed without utilizing agents executing within virtual server 330. The indexing process can scan software stack 234 contained within virtual image 332 to extract features 334 of interest. Information indicating which elements of software stack 234 should be included in extracted features 334 can be configured for flexibility. These extracted features 334 can include information such as metadata about one or more of the files in software stack 234 (e.g., their path names, file sizes, last modified date), a checksum of the contents of the files, and/or any other information from software stack 234 that can be used to detect changes in virtual server 330. In some embodiments, the contents of every file are not examined. Instead, only extracted features 334 that have been designated as being sensitive components of virtual server 330 need be extracted for use in analysis. Further, extracted features 334 could vary based on the type of passive monitoring is to be performed. For example, if the passive monitoring includes scanning for malware, executable files or other files in which malware is likely to be found can be included. In the alternative, control files of other such data files pertaining to conformance of virtual server 330 with an original template can be included in a drift detection type of passive monitoring. In any case, if analysis is to be performed on central detection server 350, extracted features 334 can then be forwarded to central detection server 350. However, it should be understood that analysis could also be performed on-site at physical server 310.

Referring still to FIGS. 1, 3 and 4, concurrently, virtual image analyzer module 148, as executed by computer system 102, can analyze extracted features 334 to perform passive monitoring of virtual server 330. This analysis can differ based on the type of passive monitoring is being performed. For example, in a drift detection analysis, virtual image analyzer module 148 can compare one or more elements of extracted features 334 with at least a portion of a corresponding pre-configured software stack 352. By comparing these two, virtual image analyzer module 148 can compute the difference between the file system structure, contents, state, etc., of each. This difference can consist of, for example, three parts: data that has been added, data that have been deleted, and data that has been modified, all relative to pre-configured software stack 352. In contrast, in a malware type analysis, extracted features 334 can be compared with signatures of known malware agents.

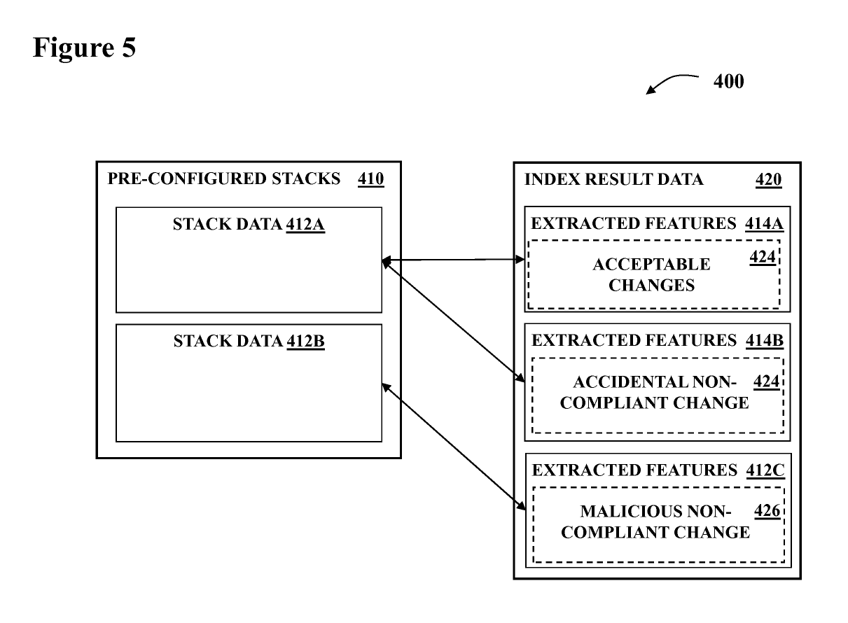

Referring now to FIG. 5, example comparison analyses 400 according to embodiments of the invention are shown. As illustrated, three sets of index results data 420 are being analyzed. These three sets of index results data 420 are being compared with two pre-configured stacks 410. As shown, extracted features 414A and 414B are from virtual servers 330 (FIG. 4) that were created from the same pre-configured stack, and, as such are being compared with the same set of stack data 412A. In contrast, extracted features 414C has been taken from a virtual server 330 of a different type created from a different pre-configured stack and is being compared with stack data 412B. Extracted features 414A is illustrated as having only acceptable changes 424, and, as such, the comparison with stack data 412A will yield only relatively small differences. In contrast, extracted features 414B and 414C both have non-compliant changes 424, 426 so both of these comparisons will yield large differences when compared with their respective stack data 412A, 412B.

Referring back to FIGS. 1, 3 and 4, concurrently, once these differences have been ascertained, passive monitoring can be performed by applying rules 354 (FIG. 4) that define what changes are non-compliant. Passive monitoring can include one or more of such activities as scanning a file system to perform a compliance check, scanning a registry to determine which applications are currently installed on the system, security scanning, file system inspection, license usage monitoring, drift detection, and/or the like. The rules 354 used to perform the passive monitoring can be configured by an administrator, a user, a third party vendor or anyone else who needs to evaluate virtual server 330 for non-compliant changes (e.g., drift, malware, etc.). Rules 354 can also be inferred statistically by analyzing differences that occur across many virtual servers 330 in virtualized datacenter environment 300 within a tolerance; can be inferred by automatically classifying files as unvarying (for example, executables), rarely changing (configuration files), or constantly changing (log files); and/or can be inferred from external sources of information such as a description of a cluster's configuration based on an evaluation performed by an evaluation tool. Similar rule-based invariants can be used to detect anomalies or malicious behavior on memory state. Examples of these include, but are not limited to: detecting unknown processes, suspicious network connections, and modifications of code segments.

In the case that non-compliant change is detected in virtual server 330, remedial action can be taken with respect to virtual server 330. For example, in the case of inadvertent or non-malicious intentional changes to a particular file, preconfigured software stack 352 can be used to repair only the non-compliant portions of software stack 234. In other cases, a more substantial portion of the software stack 234 may need to be replaced to remedy the non-compliant change. Further, in some instances, such as a pervasive malware attack, the virtual server 330 may need to be terminated and replaced with a new virtual server 330 generated using a pre-configured software stack 352. It should be understood that any solution for repairing software, and in particular a virtual server 330, now known or later developed is envisioned.

Referring now to FIGS. 2 and 4 concurrently, an advantage of this design is that it allows the indexing logic to be offloaded to locations that are physically proximate to where the systems that need to be monitored are actually running, thereby improving its scalability. As an example, say there are 100 physical servers 210, 212, 214, 216 in virtualized datacenter environment 200, and each physical server is hosting 25 virtual servers 230. By running indexing appliance 340 on each physical server 210, 212, 214, 216 (i.e., a 26^{th} virtual server 230 on each physical server 210, 212, 214, 216), a single instance of indexing appliance 340 can provide indexing services to 25 virtual servers 230 that are co-located with it. As an optimization, the virtual server 230 that includes indexing appliance 340 can be kept suspended (so that it uses little or no CPU and/or memory resources on physical server 200) when the indexing operation is not running.

Another advantage of this design is that it allows an administrator user 120 to perform simple bandwidth optimizations for network 220 to lower the volume of data used to communicate extracted features 334 back to central detection server 350. For example, the invention can locally maintain a cache of extracted features 334 that have been extracted from indexing performed on a virtual image 332 generated from an earlier scan of the same virtual server 330 (e.g., an earlier point-in-time checkpoint of that system), and only send those extracted features 334 that changed since that earlier scan to central passive monitoring server 350. This optimization can greatly cut down the amount of data transmitted over network 220. A per-server agent based approach cannot perform such optimizations.

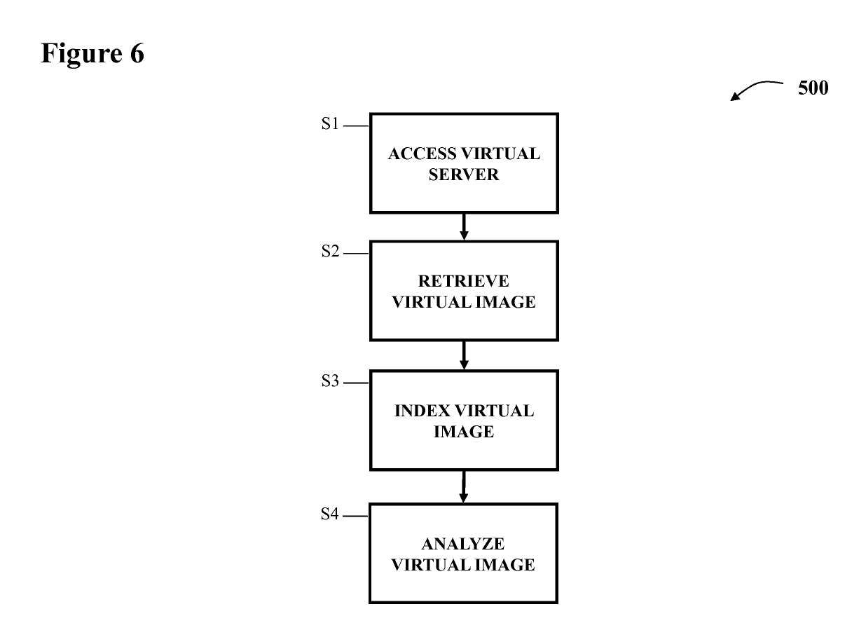

Turning now to FIG. 6, an example flow diagram according to embodiments of the invention is shown. As illustrated, in 51, virtual server accessor module 142 (FIG. 1), as executed by computer system 102 (FIG. 1), accesses virtual server 330 (FIG. 4). This virtual server 330 (FIG. 4) can be one of a plurality of virtual server 330 (FIG. 4) instances on a common physical server 310 (FIG. 4). The accessing can be by indexing agent 342 (FIG. 4) that is contained in indexing appliance 340 (FIG. 4). This indexing appliance 340 (FIG. 4) can be separate from virtual server 330 (FIG. 4) and, as such, S1 can be performed without utilizing agents executing within virtual server 330 (FIG. 4). In S2, virtual image retriever module 144 (FIG. 1), as executed by computer system 102 (FIG. 1), retrieves virtual image 332 (FIG. 4) of virtual server 330 (FIG. 4) using indexing agent 342 (FIG. 4). Because indexing agent 342 (FIG. 4) is separate from virtual server 330 (FIG. 4), S2 can be performed without utilizing agents executing within virtual server 330 (FIG. 4). In S3, virtual image indexing module 146 (FIG. 1), as executed by computer system 102 (FIG. 1), 146 indexes virtual image 332 (FIG. 4) using indexing agent (FIG. 4) 342 to extract extracted features (FIG. 4) 334 that indicate changes in virtual server 330 (FIG. 4). In S4, virtual image analyzer module 148 (FIG. 1), as executed by computer system 102 (FIG. 1), analyzes extracted features 334 (FIG. 4) to perform passive monitoring of virtual server 330.

While shown and described herein as a method and system for passively monitoring a computer system, it is understood that aspects of the invention further provide various alternative embodiments. For example, in one embodiment, the invention provides a computer program fixed in at least one computer-readable medium, which when executed, enables a computer system to passively monitor a computer system. To this extent, the computer-readable medium includes program code, such as passive monitoring program 140 (FIG. 1), which implements some or all of a process described herein. It is understood that the term “computer-readable medium” comprises one or more of any type of tangible medium of expression, now known or later developed, from which a copy of the program code can be perceived, reproduced, or otherwise communicated by a computing device. For example, the computer-readable medium can comprise: one or more portable storage articles of manufacture; one or more memory/storage components of a computing device; and/or the like.

In another embodiment, the invention provides a method of providing a copy of program code, such as passive monitoring program 140 (FIG. 1), which implements some or all of a process described herein. In this case, a computer system can process a copy of program code that implements some or all of a process described herein to generate and transmit, for reception at a second, distinct location, a set of data signals that has one or more of its characteristics set and/or changed in such a manner as to encode a copy of the program code in the set of data signals. Similarly, an embodiment of the invention provides a method of acquiring a copy of program code that implements some or all of a process described herein, which includes a computer system receiving the set of data signals described herein, and translating the set of data signals into a copy of the computer program fixed in at least one computer-readable medium. In either case, the set of data signals can be transmitted/received using any type of communications link.

In still another embodiment, the invention provides a method of generating a system for passively monitoring a computer system. In this case, a computer system, such as computer system 120 (FIG. 1), can be obtained (e.g., created, maintained, made available, etc.) and one or more components for performing a process described herein can be obtained (e.g., created, purchased, used, modified, etc.) and deployed to the computer system. To this extent, the deployment can comprise one or more of: (1) installing program code on a computing device; (2) adding one or more computing and/or I/O devices to the computer system; (3) incorporating and/or modifying the computer system to enable it to perform a process described herein; and/or the like.

The terms “first,” “second,” and the like, if and where used herein do not denote any order, quantity, or importance, but rather are used to distinguish one element from another, and the terms “a” and “an” herein do not denote a limitation of quantity, but rather denote the presence of at least one of the referenced item. The modifier “approximately”, where used in connection with a quantity is inclusive of the stated value and has the meaning dictated by the context, (e.g., includes the degree of error associated with measurement of the particular quantity). The suffix “(s)” as used herein is intended to include both the singular and the plural of the term that it modifies, thereby including one or more of that term (e.g., the metal(s) includes one or more metals). Ranges disclosed herein are inclusive and independently combinable (e.g., ranges of “up to approximately 25 wt %, or, more specifically, approximately 5 wt % to approximately 20 wt %”, is inclusive of the endpoints and all intermediate values of the ranges of “approximately 5 wt % to approximately 25 wt %,” etc).

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A method for passively monitoring a computer system, comprising:
accessing a virtual server by an indexing agent that is contained in an indexing appliance separate from the virtual server, the virtual server being one of a plurality of virtual system instances on a common physical server;
retrieving a virtual image of the virtual server by the indexing agent;
indexing the virtual image by the indexing appliance to extract a set of features indicative of changes in the virtual server; and
analyzing at least one of the set of features to perform passive monitoring of the virtual server,
wherein the retrieving and the indexing are performed without utilizing agents executing within the virtual server.

2. The method of claim 1, further comprising generating the plurality of virtual system instances using a pre-configured software stack.

3. The method of claim 2, wherein the analyzing includes comparing an element of the set of features with at least a portion of the pre-configured software stack.

4. The method of claim 1, the analyzing further comprising:
designating a set of sensitive components of the virtual server; and
informing a user in response to the analyzing indicating a non-compliant change has occurred in the set of sensitive components.

5. The method of claim 1, wherein the indexing appliance is included in a virtual system instance on the common physical server that is different from the virtual server.

6. The method of claim 1, further comprising, prior to the retrieving:
establishing a checkpoint using a built-in snapshot feature of a virtualization layer of the virtual server; and
generating the virtual image containing a file system and a running state of the virtual server at a time of the checkpoint.

7. The method of claim 1, further comprising:
receiving, prior to the retrieving, a request from a central detection server at the indexing appliance, the request requesting the indexing appliance to perform passive monitoring on the virtual server;
forwarding data corresponding to the set of features from the indexing appliance to the central detection server; and
performing the analyzing at the central detection server.

8. The method of claim 1, wherein the set of features is indicative of whether drift has occurred in the virtual server and wherein the analyzing includes determining whether drift has occurred in the virtual server.

9. A system for passively monitoring a computer system, comprising:
a physical server having a plurality of virtual system instances operating thereon; and
an indexing appliance operating on the physical server, which performs a method comprising:
using an indexing agent that is contained in the indexing appliance to access a virtual server from among the plurality of virtual systems instances, the virtual server being separate from the indexing appliance;
retrieving a virtual image of the virtual server by the indexing agent;
indexing the virtual image by the indexing appliance to extract a set of features indicative of changes in the virtual server; and
analyzing at least one of the set of features to perform passive monitoring of the virtual server,
wherein the retrieving and the indexing are performed without utilizing agents executing within the virtual server.

10. The system of claim 9, the method further comprising generating the plurality of virtual system instances using a pre-configured software stack.

11. The system of claim 9, wherein the indexing includes comparing an element of the set of features with at least a portion of the pre-configured software stack.

12. The system of claim 9, the analyzing further comprising:
designating a set of sensitive components of the virtual server; and
informing a user in response to the analyzing indicating a non-compliant change has occurred in the set of sensitive components.

13. The system of claim 9, wherein the indexing appliance is included in a virtual system instance on the common physical server that is different from the virtual server.

14. The system of claim 9, further comprising, prior to the retrieving:
establishing a checkpoint using a built-in snapshot feature of a virtualization layer of the virtual server; and
generating the virtual image containing a file system and a running state of the virtual server at a time of the checkpoint.

15. The system of claim 9, further comprising:
receiving, prior to the retrieving, a request from a central detection server at the indexing appliance, the request requesting the indexing appliance to perform passive monitoring on the virtual server;
forwarding data corresponding to the set of features from the indexing appliance to the central detection server; and
performing the analyzing at the central detection server.

16. The system of claim 9, wherein the set of features is indicative of whether drift has occurred in the virtual server and wherein the analyzing includes determining whether drift has occurred in the virtual server.

17. A computer program product embodied in a computer readable medium for implementing a method for passively monitoring a computer system, the method comprising:
accessing a virtual server by an indexing agent that is contained in an indexing appliance separate from the virtual server, the virtual server being one of a plurality of virtual system instances on a common physical server;
retrieving a virtual image of the virtual server by the indexing agent;
indexing the virtual image by the indexing appliance to extract a set of features indicative of changes in the virtual server; and
analyzing at least one of the set of features to perform passive monitoring of the virtual server,
wherein the retrieving and the indexing are performed without utilizing agents executing within the virtual server.

18. The program product of claim 17, the method further comprising generating the plurality of virtual system instances using a pre-configured software stack.

19. The program product of claim 17, wherein the analyzing includes comparing an element of the set of features with at least a portion of the pre-configured software stack.

20. The program product of claim 17, the analyzing further comprising:
designating a set of sensitive components of the virtual server; and
informing a user in response to the analyzing indicating a non-compliant change has occurred in the set of sensitive components.

21. The program product of claim 17, wherein the indexing appliance is included in a virtual system instance on the common physical server that is different from the virtual server.

22. The program product of claim 17, further comprising, prior to the retrieving:
establishing a checkpoint using a built-in snapshot feature of a virtualization layer of the virtual server; and
generating the virtual image containing a file system and a running state of the virtual server at a time of the checkpoint.

23. The program product of claim 17, further comprising:
receiving, prior to the retrieving, a request from a central detection server at the indexing appliance, the request requesting the indexing appliance to perform passive monitoring on the virtual server;
forwarding data corresponding to the set of features from the indexing appliance to the central detection server; and
performing the analyzing at the central detection server.

24. The program product of claim 17, wherein the set of features is indicative of whether drift has occurred in the virtual server and wherein the analyzing includes determining whether drift has occurred in the virtual server.

25. A method for deploying an application for passively monitoring a computer system, comprising:
providing a computer infrastructure being operable to:
access a virtual server by an indexing agent that is contained in an indexing appliance separate from the virtual server, the virtual server being one of a plurality of virtual system instances on a common physical server;
retrieve a virtual image of the virtual server by the indexing agent;
index the virtual image by the indexing appliance to extract a set of features indicative of changes in the virtual server; and
analyze at least one of the set of features to perform passive monitoring of the virtual server,
wherein the retrieving and the indexing are performed without utilizing agents executing within the virtual server.
